(19) United States
(12) Patent Application Publication
(10) Pub. No.: US 2006/0038755 A1
(43) Pub. Date: Feb. 23, 2006

(54) Light emitting device and method thereof

(76) Inventors: Kyoung-Soo Lee, Suwon-si (KR); Sung-Chon Park, Suwon-si (KR)

Correspondence Address: CHRISTIE, PARKER & HALE, LLP, PO BOX 7068, PASADENA, CA, 91109-7068, US

(21) Appl. No.: 11/203,052

(22) Filed: Aug. 12, 2005

(30) Foreign Application Priority Data
Aug. 20, 2004 (KR) 10-2004-0065776

(51) Int. Cl. G09G 3/30

(52) U.S. Cl. 345/76

(57) ABSTRACT

A display panel driver of a display device having a main panel and a sub-panel, the display panel driver including a scan driver for selectively applying selection signals to a plurality of scan lines; a data driver for applying data voltages corresponding to image signals to a plurality of data lines; and a drive controller for selectively enabling a part of the scan driver while synchronously driving the data driver, wherein the main panel and the sub-panel are arranged in opposite directions, and wherein the scan driver comprises a main scan driver for driving the main panel and a sub-scan driver for driving the sub-panel. With this configuration, control signals different from the enable signal are inputted to the main scan and sub-scan drivers, and therefore, a driving integrated circuit (IC) can be readily designed.

### CROSS REFERENCE TO RELATED APPLICATION

This application claims priority to and the benefit of Korean Patent Application No. 10-2004-0065776, filed on Aug. 20, 2004 in the Korean Intellectual Property Office, the entire content of which is incorporated herein by reference.

### BACKGROUND OF THE INVENTION

1. Field of the Invention

The present invention relates to a display panel driver of a light emitting display and a method for driving the same, and more particularly, it relates to a display panel driver for driving main and sub-panels of an organic light emitting diode display and a method of driving the same.

2. Description of the Related Art

In a general organic light emitting diode display, phosphorus organic components are disposed into pixels arranged in a matrix format, and an image is represented by controlling the amount of a current flowing to the phosphorus organic components. The organic light emitting diode display is an advanced display device having a high responsiveness, a low power consumption, and a wide view angle. Thus, the organic light emitting diode display is expected to be a next-generation display device.

FIG. 1 illustrates a light emission mechanism of an organic light emitting diode display (hereinafter, referred to as an OLED display).

In general, an OLED display electrically excites phosphorus organic components, and represents an image by voltage-programming or current-programming n×m numbers of organic light emitting pixels. As shown in FIG. 1, each of these organic light emitting pixels includes an indium tin oxide (ITO) pixel electrode, an organic thin film, and a metal layer. As shown in FIG. 1, the organic thin film has a multi-layered structure including an emission layer (EML), an electron transport layer (ETL), and a hole transport layer (HTL) so as to balance electrons and holes and thereby enhance efficiency of light emission. Further, the organic thin film includes an electron injection layer (EIL) and a hole injection layer (HIL).

Methods of driving the organic light emitting pixels having the foregoing configuration can include a passive matrix method and an active matrix method. The active matrix method employs a thin film transistor (TFT). In the passive matrix method, an anode electrode and a cathode electrode are formed crossing each other and lines are selected to drive the organic light emitting pixels. On the other hand, in the active matrix method, each indium tin oxide (ITO) pixel electrode is coupled to the TFT, and the light emitting pixel is driven in accordance with a voltage maintained by capacitance of a capacitor coupled to a gate of the TFT.

Recently, a folder-type cellular phone has become popular, and OLED displays different in sizes are disposed on inner and external sides of the phone. In this case, the OLED on the inner side is larger than the OLED on the external side.

Therefore, the OLED displays having different sizes may be required to be independently controlled. In this case, the OLED displays may require twice the number of parts, thereby increasing a manufacturing cost.

### SUMMARY OF THE INVENTION

An embodiment of the present invention provides a display panel driver of a light emitting display having OLED panels disposed on both sides of the light emitting display and a method for driving the same to control one of a main panel and a sub-panel to be selected for emitting light.

In addition, an embodiment of the present invention provides a display panel driver of a light emitting display and a method for driving the same to control a main scan driver and a sub-scan driver to share control signals except an enable signal, which enables one of the main scan driver and the sub-scan driver to be activated.

One embodiment of the present invention provides a display panel driver of a display device having a main panel and a sub-panel. The display panel driver includes a scan driver, a data driver, and a drive controller. The scan driver sequentially applies selection signals to a plurality of scan lines. The data driver applies data voltages corresponding to image signals to a plurality of data lines. The drive controller selectively enables a part of the scan driver while synchronously driving the data driver. In the present embodiment, the main panel and the sub-panel are arranged in opposite directions, and the scan driver includes a main scan driver for driving the main panel and a sub-scan driver for driving the sub-panel.

The display panel driver may further include an inverter for inverting an enable signal outputted from the drive controller.

One of the enable signal and the inverted enable signal may be inputted to the main scan driver and the other one of the enable signal and the inverted enable signal may be inputted to the sub-scan driver.

Control signals different from the enable signal may be inputted to both of the main scan driver and the sub-scan driver.

One embodiment of the present invention provides a light emitting display having a main panel for a frontward display of the light emitting display, a sub-panel for a rearward display of the light emitting display, a main scan driver, a sub-scan driver, a data driver, and a drive controller. The main scan driver sequentially applies respective selection signals to a plurality of scan lines in the main panel. The sub-scan driver sequentially applies respective selection signals to a plurality of scan lines in the sub-panel. The data driver applies data voltages to selected pixel circuits of the main panel and the sub-panel. The data voltages correspond to image signals. The drive controller selectively enables one of the main scan driver and the sub-scan driver while synchronously driving the data driver.

The main panel and the sub-panel may share data lines for applying the data voltages corresponding to the image signals.

The light emitting display may further include an inverter for inverting an enable signal outputted from the drive controller.

One of the enable signal and the inverted enable signal may be inputted to the main scan driver, and the other one of the enable signal and the inverted signal may be inputted to the sub-scan driver.

Control signals different from the enable signal may be inputted to both of the main scan driver and the sub-scan driver.

One embodiment of the present invention provides a method for driving a display panel of a light emitting display having a main panel and a sub-panel respectively disposed on front and rear sides of the light emitting display. In the method, an enable signal for selecting one of a main scan driver for driving the main panel and a sub-scan driver for driving the sub-panel is outputted, the enable signal is inverted, selection signals are sequentially applied to a plurality of scan lines of the main panel or a plurality of scan lines of the sub-panel in accordance with the enable signal and the inverted enable signal, and a plurality of data voltages are sequentially applied to pixel circuits selected from the scan lines of the main panel and the sub-panel to enable display of the selected one of the main panel and the sub-panel to display an image thereon. The data voltages correspond to image signals.

In the method, the enable signal may be inverted by using an inverter.

### BRIEF DESCRIPTION OF THE DRAWINGS

FIG. 1 shows an emission mechanism of an organic light emitting diode display.

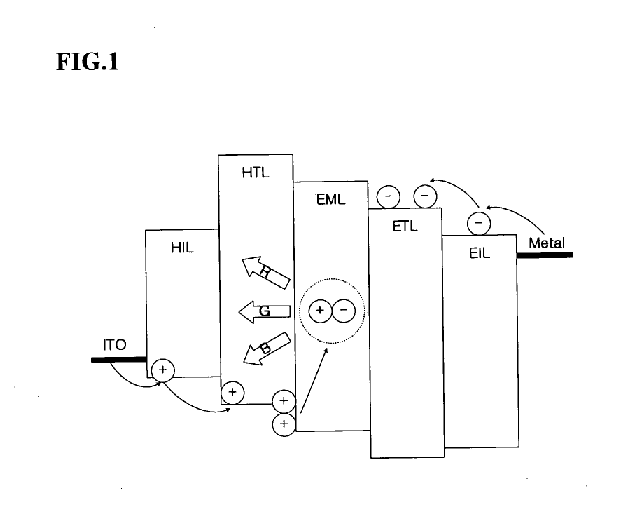

FIG. 2 is a schematic block diagram of an organic light emitting diode (OLED) display according to an embodiment of the present invention.

FIG. 3 illustrates an OLED panel employing an active matrix method using a thin film transistor (TFT).

FIG. 4A and FIG. 4B are external views of a main panel and a sub-panel of a mobile phone having a light emitting display according to an embodiment of the present invention.

FIG. 5 schematically shows a configuration of a display panel driver of a light emitting display according to an embodiment of the present invention.

### DETAILED DESCRIPTION

In the following detailed description, only certain exemplary embodiments of the present invention are shown and described, simply by way of illustration. As those skilled in the art would realize, the described embodiments may be modified in various different ways, all without departing from the spirit or scope of the present invention.

Accordingly, the drawings and description are to be regarded as illustrative in nature, and not restrictive. There may be parts shown in the drawings, or parts not shown in the drawings, that are not discussed in the specification, as they are not essential to a complete understanding of the invention. Like reference numerals designate like elements.

Hereinafter, a display panel driver of a light emitting display and a method thereof according to an embodiment of the present invention will be described in detail with reference to the accompanying drawings.

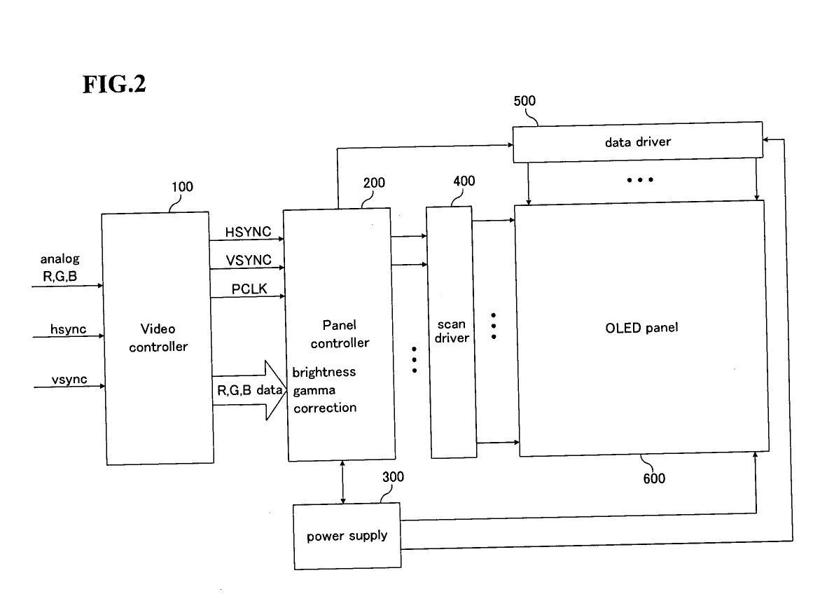

FIG. 2 is a schematic block diagram of an organic light emitting diode (OLED) display according to an embodiment of the present invention.

As shown therein, the OLED display according to the embodiment of the present invention includes a video controller 100, a panel controller 200, a power supply (or module) 300, a scan driver 400, a data driver 500, and an OLED panel 600.

In the OLED display according to FIG. 2, various signals that have passed through analog and digital interfaces are applied to the OLED panel 600 in a column direction by the scan driver 400 and in a row direction by the data driver 500.

In more detail, various analog signals including RGB (red, green, and blue) signals, a vertical synchronization signal, and a horizontal synchronization signal are inputted to the video controller 100 so as to be converted into digital signals. The panel controller 200 that controls the converted digital signals sequentially supplies the converted digital signals to the scan driver 400 and the data driver 500. The OLED panel 600 displays an image by voltage-driving or current-driving n×m numbers of organic light emitting pixels using a power from the power supply 300 and signals through the scan driver 400 and the data driver 500.

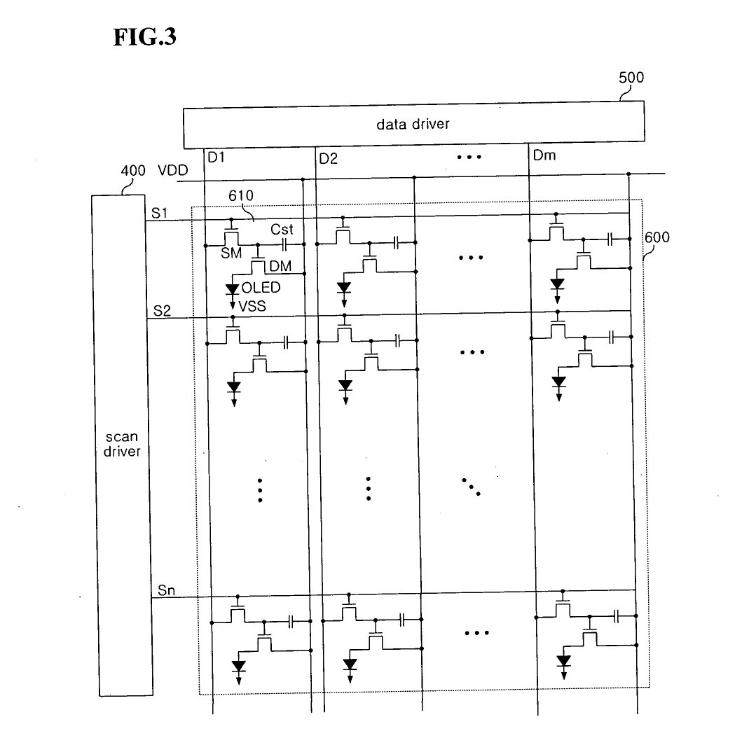

FIG. 3 illustrates an OLED panel employing an active matrix method using a thin film transistor (TFT) according to an embodiment of the present invention.

Referring to FIG. 3, an OLED display according to the embodiment of the present invention includes an OLED panel 600, a scan driver 400, and a data driver 500.

The OLED panel 600 includes data lines D1 to Dm arranged in rows, scan lines S1 to Sn arranged in columns, and n×m numbers of pixel circuits. The data lines D1 to Dm are for transmitting data signals as image signals to the pixel circuits, and the scan lines S1 to Sn are for transmitting selection signals to the pixel circuits. Herein, a pixel circuit is formed on a single pixel area 610 defined by two adjacent data lines of the data lines D1 to Dm and two adjacent scan lines of the scan lines S1 to Sn.

The scan driver 400 sequentially applies the selection signals to the scan lines S1 to Sn, and the data driver 500 applies data voltages corresponding to the image signals to the data lines D1 to Dm.

The scan driver 400 and/or the data driver 500 may be electrically coupled to the OLED panel 600 using various schemes. For example, the scan driver 400 and/or the data driver 500 may be electrically coupled to the OLED panel 600 using a chip installed with various types of electrical connection members, such as a tape carrier package (TCP), a flexible printed circuit (FPC), and/or a film.

On the other hand, the scan driver 400 and the data driver 500 may be directly attached to a glass substrate of the display panel 600, or they may be realized as a driving circuit that is formed on a glass substrate and has a layer structure similar to scan lines, data lines, and the TFTs.

Further, the pixel circuit formed on the single pixel area 610 includes an OLED, a switching transistor SM, a driving transistor DM, and a capacitor Cst. As an example, the switching and driving transistors may each be formed using a PMOS-type transistor.

A source of the driving transistor DM is coupled to a power voltage VDD, and the capacitor Cst is arranged between a gate and the source of the driving transistor DM and coupled thereto. The capacitor Cst maintains a gate-source voltage of the driving transistor DM for a predetermined period of time, and the driving transistor DM outputs a current corresponding to the gate-source voltage maintained by the capacitor Cst, i.e., the voltage difference between the gate and the source of the driving transistor DM. The switching transistor SM applies the data signal from a data line (e.g., the data line D1) to the driving transistor DM in response to the selection signal from a current scan line (e.g., the scan line S1).

A cathode of the OLED is coupled to a reference voltage Vss, and emits light corresponding to the current applied through the driving transistor DM. In one embodiment, the reference voltage Vss coupled to the cathode of the OLED is lower than the power voltage VDD. As an example, a ground voltage may be used for the reference voltage Vss.

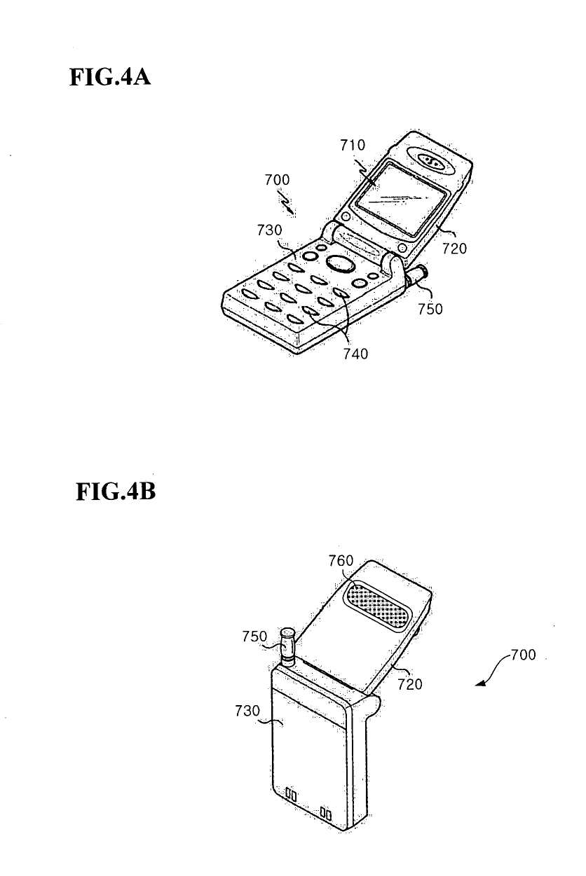

FIG. 4A and FIG. 4B respectively show an external view of a main panel 710 formed on a front side and a sub-panel 760 formed on a rear side of a portable terminal (hereinafter, referred to as a mobile phone) 700.

Referring to FIG. 4A and FIG. 4B, the mobile phone 700 having the light emitting display according to an embodiment of the present invention includes the main panel 710, a folder 720, a keypad 740, a dual-folder type main body 730 on which the keypad 740 is mounted, an antenna 750, and the sub-panel 760.

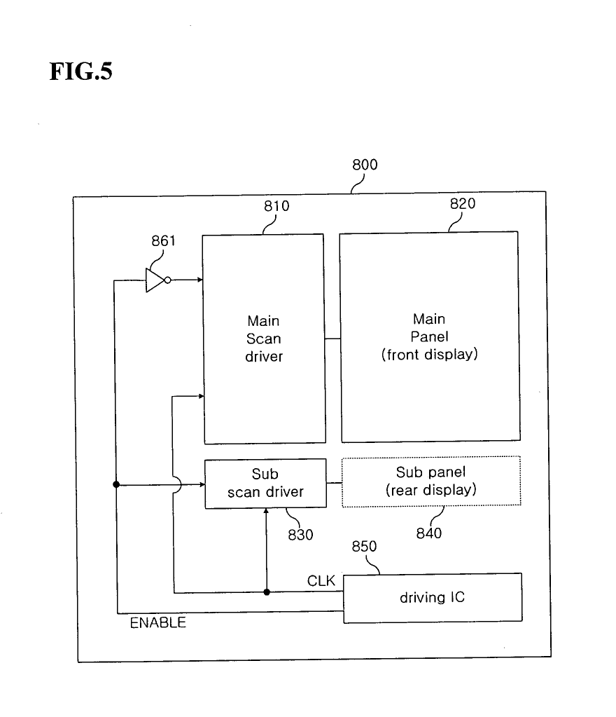

FIG. 5 shows a schematic configuration of a display panel driver according to an embodiment of the present invention.

Referring to FIG. 5, the display panel driver according to the embodiment of the present invention is realized in a display panel 800 of a light emitting display having a main panel 820 and a sub-panel 840. The main panel 820 is disposed on a front side of the light emitting display, and the sub-panel 840 is disposed on a rear side of the light emitting display.

Herein, a main scan driver 810 sequentially applies selection signals to a plurality of scan lines of the main panel 820 along a first direction, and a sub-scan driver 830 sequentially applies selection signals to a plurality of scan lines of the sub-panel 840.

A data driver (not shown) applies data voltages corresponding to image signals to selected pixel circuits of the main panel 820 and the sub-panel 840.

In addition, a driving integrated circuit (IC) 850 that controls driving of the panels 820 and 840 selectively enables the main scan driver 810 and the sub-scan driver 830 such that only one of the drivers 810 and 830 may operate while the data driver is driven. For this purpose, an inverter may be provided to the driving IC 850, for inversion of an enable signal produced at the driving IC 850. The enable signal from the driving IC 850 may be in the form of a high enable signal or a low enable signal. Regardless of the form of the enable signal, the inverter 861 may be provided in front of either of the main scan driver 810 or the sub-scan driver 830. In either case, one of the enable signal and an inverted enable signal is inputted to the main scan driver 810, and the other one of the enable signal and the inverted enable signal is inputted to the sub-scan driver 830.

Control signals which are different from the enable signal are inputted to the main scan and sub-scan drivers 810 and 830. For example, a clock signal is inputted to the drivers 810 and 830.

In a method for driving a display panel of a light emitting display according to an embodiment of the present invention, an enable signal is outputted for selecting one of a main scan driver (e.g., the main scan driver 810) driving a main panel (e.g., the main panel 820) and a sub-scan driver (e.g., the sub-scan driver 830) driving a sub-panel (e.g., the sub-panel 840), and an inverter is used to invert the outputted enable signal. Selection signals are sequentially applied to the scan lines of the main panel or the sub-panel according to the enable signal and the inverted enable signal. A plurality of data voltages corresponding to image signals are sequentially applied to selected pixel circuits of the main panel or the sub-panel so as to enable one of the main panel and the sub-panel to display an image thereon.

According to an embodiment of the present invention, when a main panel and a sub-panel are realized on a signal mobile phone, a main scan driver and a sub-scan driver are driven such that one of the main scan driver and the sub-scan driver is selected by using an enable signal to enable operation of the selected scan driver and to disable operation of the other one of the main scan driver and the sub-scan driver to thereby prevent the main and sub-scan drivers from being operated simultaneously.

According to an embodiment of the present invention, when a main panel and a sub-panel are disposed on both sides of an OLED display, one of a main scan driver and a sub-scan driver is selected to emit light with its respective panel.

In addition, according to an embodiment of the present invention, control signals different from an enable signal are inputted to a main scan driver and a sub-scan driver. Therefore, a driving IC can be readily designed.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A display panel driver of a display device having a main panel and a sub-panel, the display panel driver comprising:
a scan driver for selectively applying selection signals to a plurality of scan lines;
a data driver for applying data voltages corresponding to image signals to a plurality of data lines; and
a drive controller for selectively enabling a part of the scan driver while synchronously driving the data driver,
wherein the main panel and the sub-panel are arranged in opposite directions, and wherein the scan driver comprises a main scan driver for driving the main panel and a sub-scan driver for driving the sub-panel.

2. The display panel driver of claim 1, further comprising an inverter for inverting an enable signal outputted from the drive controller.

3. The display panel driver of claim 2, wherein one of the enable signal and the inverted enable signal is inputted to the main scan driver and another one of the enable signal and the inverted enable signal is inputted to the sub-scan driver.

4. The display panel driver of claim 2, wherein control signals different from the enable signal are inputted to both of the main scan driver and the sub-scan driver.

5. A light emitting display comprising:
a main panel for a frontward display of the light emitting display;
a sub-panel for a rearward display of the light emitting display;
a main scan driver for sequentially applying respective selection signals to a plurality of scan lines in the main panel;
a sub-scan driver for sequentially applying respective selection signals to a plurality of scan lines in the sub-panel;
a data driver for applying data voltages to selected pixel circuits of the main panel and the sub-panel, the data voltages corresponding to image signals; and
a drive controller for selectively enabling one of the main scan driver and the sub-scan driver while synchronously driving the data driver.

6. The light emitting display of claim 5, wherein the main panel and the sub-panel share a plurality of data lines for applying the data voltages corresponding to the image signals.

7. The light emitting display of claim 5, further comprising an inverter for inverting an enable signal outputted from the drive controller.

8. The light emitting display of claim 7, wherein one of the enable signal and the inverted enable signal is inputted to the main scan driver and another one of the enable signal and the inverted enable signal is inputted to the sub-scan driver.

9. The light emitting display of claim 7, wherein control signals different from the enable signal are inputted to both of the main scan driver and the sub-scan driver.

10. A method for driving a display panel of a light emitting display having a main panel and a sub-panel respectively disposed on front and rear sides of the light emitting display, the method comprising:
outputting an enable signal for selecting one of a main scan driver for driving the main panel and a sub-scan driver for driving the sub-panel;
inverting the enable signal;
sequentially applying selection signals to a plurality of scan lines of the main panel or a plurality of scan lines of the sub-panel in accordance with the enable signal and the inverted enable signal; and
enabling display of a selective one of the main panel and the sub-panel by sequentially applying a plurality of data voltages to pixel circuits selected from the main panel and the sub-panel, the plurality of data voltages corresponding to image signals.

11. The driving method of claim 10, wherein in the inverting of the enable signal, the enable signal is inverted by an inverter.

12. The driving method of claim 10, wherein control signals different from the enable signal are input to both of the main scan driver and the sub-scan driver.

13. The driving method of claim 10, wherein the main scan driver and the sub-scan driver share data lines for receiving the data voltages corresponding to the image signals.
